(19) United States
(12) Patent Application Publication
(10) Pub. No.: US 2026/0193474 A1
(43) Pub. Date: Jul. 9, 2026

(54) COATINGS WITH EMBEDDED PIGMENTS

(71) Applicant: PPG Industries Ohio, Inc., Cleveland, OH (US)

(72) Inventors: Vijesh Anant Tanna, Pittsburgh, PA (US); Ronald James Kralic, Jr., Beaver Falls, PA (US); Corey James DeDomenic, Trafford, PA (US); Abdulrahman Dawoud Ibrahim, Cleveland, OH (US); Douglas Gordon Montjoy, Pittsburgh, PA (US); Vincent Salvatore Pagnotti, Jr., Wexford, PA (US)

(73) Assignee: PPG Industries Ohio, Inc., Cleveland, OH (US)

(21) Appl. No.: 19/133,755

(22) PCT Filed: Dec. 6, 2023
(86) PCT No.: PCT/US2023/082623

§ 371 Date: May 29, 2025

Related U.S. Application Data
(60) Provisional application No. 63/386,196, filed on Dec. 6, 2022.

(51) Int. Cl. C09D 5/10; C09D 5/08; C09D 5/44; C09D 7/20; C09D 7/40; C09D 7/61

(52) U.S. Cl. CPC C09D 5/103; C09D 5/084; C09D 5/448; C09D 7/20; C09D 7/61; C09D 7/70

(57) ABSTRACT

A hardened coating layer that includes a film forming component and a pigment component that includes a pigment is disclosed. The pigment component can be applied to at least a portion of a surface of the film forming component that is at least partially unhardened when the pigment component is applied, such that the pigment becomes embedded in the film forming component, where the pigment component does not itself form a film.

### CROSS-REFERENCE TO RELATED APPLICATION

This application claims the benefit of priority of U.S. Provisional Application 63/386,196 filed Dec. 6, 2022, under 35 U.S.C. 119, titled “Coatings with Embedded Pigments”, which is incorporated herein by reference.

### FIELD

This disclosure generally relates to a hardened coating layer in which pigment is embedded, methods for making same, and substrates coated therewith.

### BACKGROUND

Coatings can be applied to a wide variety of substrates to provide color and other visual effects, such as designs and patterns, and/or performance effects, such as corrosion resistance. Improved coating layers and methods for applying the same are always desired.

### SUMMARY

This disclosure describes a hardened coating layer that includes a film forming component and a pigment component that includes a pigment, where the pigment component is applied to at least a portion of a surface of the film forming component that is at least partially unhardened when the pigment component is applied, such that the pigment becomes embedded in the film forming component and where the pigment component does not itself form a film. Methods for making such layers and substrates coated therewith are also within the present disclosure.

This disclosure further describes a hardened coating layer formed by: (a) applying a film forming component to at least a portion of a substrate; (b) applying a pigment component that includes a pigment to at least a portion of a surface of the film forming component that is at least partially unhardened when the pigment component is applied, such that pigment becomes embedded in the film forming component; and (c) hardening the coating layer; where the pigment component does not itself form a film. Methods for making such layers and substrates coated therewith are also within the present disclosure.

### DESCRIPTION OF THE DRAWINGS

FIGS. 1a, 1b and 1c show a depiction of a cross-sectional view of hardened coating layers described herein.

FIG. 2 shows scanning electron microscope (SEM) cross-sections of the coatings of examples 14 and 15.

### DETAILED DESCRIPTION

Unless otherwise indicated, conditions of temperature and pressure are ambient temperature (22° C.), a relative humidity of 45%, and standard pressure of 101.3 kPa (1 atm).

Unless otherwise indicated, any term containing parentheses refers to the term both with and without the parenthetical material. Thus, as used herein the term, “(meth)acrylate” and like terms is intended to include acrylates, methacrylates, or both.

It is to be understood that this disclosure may assume various alternative variations and step sequences, except where expressly specified to the contrary. Accordingly, unless indicated to the contrary, the numerical parameters set forth in the following specification and attached claims are approximations that can vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure may be approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

All ranges are inclusive and combinable. For example, the term “a range of from 0.06 to 0.25 wt. %, or from 0.06 to 0.08 wt. %” would include each of from 0.06 to 0.25 wt. %, from 0.06 to 0.08 wt. %, and from 0.08 to 0.25 wt. %. Further, when ranges are given, any endpoints of those ranges and/or numbers recited within those ranges can be combined within the scope of the present disclosure.

Unless otherwise stated, plural encompasses singular and vice versa. As used herein, the term “including” and like terms means “including but not limited to”. Similarly, as used herein, the terms “on”, “applied on/over”, “formed on/over”, “deposited on/over”, “overlay” and “provided on/over” mean formed, overlaid, deposited, or provided on but not necessarily in contact with the surface. For example, a coating layer “formed over” a substrate does not preclude the presence of one or more other coating layers of the same or different composition located between the formed coating layer and the substrate.

As used herein, the articles “a”, “an”, and “the” include plural references unless expressly and unequivocally limited to one referent and shall be construed to include “one or more”. Therefore, reference to “a” hardened coating layer, “a” film forming component, “a” pigment component comprising “a” pigment, and the like refers to one or more of any of these items.

As used herein, the term “abrasion resistant particle” refers to particulates that impart wear and scratch resistance and can include, as nonlimiting examples, diamond; crystalline materials, such as polycrystalline materials, monocrystalline materials, or a combination thereof; amorphous materials; ceramic materials; glass-ceramic materials; superabrasive materials; minerals; carbon-based materials; or any combination thereof.

As used herein, “adhesive layer” refers to a coating layer that can bond two materials together by adhering to a surface of each; as a nonlimiting example, the adhesive layer can produce a joint having both a lap shear strength of at least 20.0 MPa, measured according to ASTM D1002-10 using 2024-T3 aluminum substrate of 1.6 mm thickness, as measured by an INSTRON 5567 machine in tensile mode with a pull rate of 1.3 mm per minute.

As used herein, the term “ASTM” refers to publications of ASTM International, West Conshohocken, PA.

As used herein, the term “basecoat” refers to a coating layer that is applied onto a primer, another basecoat layer, and/or directly onto a substrate, optionally including components (such as colorants) that color and/or provide other visual effect.

As used herein, the term “brightness” refers to the luminance at 15° (L*15°) of a coating layer applied to a substrate as determined using a BYK-Mac I metallic color spectrophotometer instrument manufactured by BYK-Gardner.

As used herein the term “clearcoat” refers to a coating layer that is at least substantially transparent if not fully transparent and may or may not include a colorant. The term “substantially transparent” refers to a coating wherein a surface beyond the coating layer is at least partially visible to the naked eye when viewed through the coating. The term “fully transparent” refers to a coating wherein a surface beyond the coating layer is completely visible to the naked eye when viewed through the coating. The clearcoat can be substantially free of a pigment. Substantially free of a pigment can refer to a “tinted clearcoat”, which can be a coating composition that includes less than 3 weight % of pigment and/or dye, based on the total solids, such as less than 2 weight %, less than 1 weight %, or 0 weight %.

As used herein, the term “coating” or “coating layer” refers to the finished product resulting from applying one or more coating compositions to a substrate and hardening or curing the composition. A primer layer, basecoat layer, topcoat layer, and clearcoat layer can all be coating layers according to the present disclosure.

As used herein, the term “colorant” refers to any substance that imparts color and/or other opacity and/or other visual effect to a coating composition and can include, without limitation, dyes and pigments.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure. As used herein, “consisting essentially of” means the specified materials or steps listed as well as those that do not materially affect the basic characteristics disclosed; “consisting of” means only the specified materials or steps.

As used herein, the terms “crosslinking agent”, “crosslinker”, “curing agent” and the like refer to a molecule or polymer containing a functional group reactive with a functional group of the polymers and/or resins in the coating composition.

As used herein, the terms “curable”, “cure”, “hardenable” and the like, as used in connection with a composition, refer to the ability of at least a portion of their polymerizable and/or crosslinkable components to undergo a reaction. Cure and harden and like terms may be used interchangeably herein.

As used herein, “cure potential”, “hardening potential” or like terms refer to the amount of reaction that can potentially occur in a composition determined by the amount of reactive functional groups and, in some cases, crosslinking agents present in a composition. A partial cure/hardening of X % of cure/hardening potential indicates that X mol % of the reactive functional groups present have reacted, where X is less than all of the groups capable of undergoing reaction. A film forming component or hardenable composition that is “at least partially unhardened” therefore refers to a partial cure/hardening; that is, it means that not all of the polymerizable or crosslinkable components have reacted yet.

As used herein, the terms “dry”, “dried”, “drying” and like terms refer to the removal of volatile compounds from a film, or composition.

As used herein, the term “dye” refers to a colored substance, which may include an organic compound, that can impart color to a composition.

As used herein, the term “dry film thicknesses” refers to the thickness of a coating layer after it has been cured and/or hardened and can be measured using a Fischerscope MMS Permascope according to ASTM D7091-21, “Standard practice for nondestructive measurement of dry film thickness of nonmagnetic coatings applied to ferrous metals and nonmagnetic, nonconductive coatings applied to non-ferrous metals”.

As used herein, “embed”, “embedded” and like terms refer to enclosing, either partially or completely, in a matrix, such as the film forming component. Pigments according to the present disclosure can be completely embedded or only partially embedded in the film forming component.

As used herein, the term “electrically conductive particles” refers to materials that can serve as a pair of electrodes or current collectors, such as electrically conductive carbon, metals, metal oxides, graphene, or a combination thereof and can be in various forms, such as nanoparticles, microparticles, nanowires, microwires, nanotube, microtubes, or other forms or a combination of such forms.

As used herein, the terms “electrocoat”, “ecoat”, “e-coat” and the like refer to a coating applied by a process where electrically charged particles are deposited out of a suspension to coat a conductive part. During this process, a coating is applied to a part at a certain film thickness, which is regulated by the amount of voltage applied. The deposition can be self-limiting and may slow down as the applied coating electrically insulates the part.

As used herein, the term “film-forming component” refers to film-forming constituents of a coating composition and can include polymers, resins, crosslinking materials or any combination thereof that can form a self-supporting continuous film on at least a horizontal surface of a substrate upon hardening. The coating composition can be thermosetting or thermoset, wherein components react to form covalent bonds that are not reversible, or thermoplastic or thermoplast, wherein the reaction between components does not form covalent bonds and can be reversed, such as by heating.

As used herein, the terms “flop” or “flop index” refer to the measurement of the change in reflectance of a coated substrate as it is rotated through a range of viewing angles. as measured using a spectrophotometer such as a BYK-Mac I Spectrophotometer of BYK Co. A solid color coating will typically have a flop index of 0, while a coating comprising metallic or pearlescent pigments will typically have a flop value that can be considered high or low depending on the type of pigment. For example, non-transparent pigments will typically result in coatings having low flop (less than 15), while coatings with transparent and/or metallic pigments a high flop (15-17). Flop index is a unitless value.

As used herein, the terms “glass transition temperature” or “Tg” refer to the temperature at which a material, often a polymer, transforms from a glassy to a rubbery state with increasing temperature. Any Tg values reported herein were determined using ASTM E1356-08 (2014).

As used herein, the term “low temperature cure” in reference to a coating means that the coating cures at a temperature of 140° C. or less, such as 80° C. to 140° C.

As used herein, the term “magnetic particles” refers to particles having ferromagnetic, ferrimagnetic, superparamagnetic, and/or superferrimagnetic behavior, such as iron, cobalt, and nickel and their oxides and/or alloys such as CoPt, FePt, FeNi, or FeCo AlNiCo, CoPt, FeCoCr and combinations thereof.

Unless otherwise indicated, as used herein, the term “molecular weight” refers to a weight average molecular weight as determined by gel permeation chromatography (GPC) using appropriate polystyrene standards. If a number average molecular weight is specified, the weight is determined in the same GPC manner, while calculating a number average from the thus obtained polymer molecular weight distribution data.

As used herein “multi component”, which can be “two component” or “2K”, and like terms refer to a composition that includes a first component that contains a functional material and at least one other component that contains functional material reactive with that in the first component. Typically, the components are maintained separately until just prior to use and react when combined.

As used herein the terms “one component”, “1K” and the like refer to a composition where all of the components are maintained in the same package after manufacture, during shipping and storage; a composition is considered a 1-K coating composition even if solvent(s) are added to the 1-K composition to lower the viscosity or solids thereof.

As used herein, the term “organic solvent” refers to carbon-based substances capable of dissolving or dispersing other substances.

As used herein, the term “pigment component comprising a pigment” refers to a component that is applied to an at least partially unhardened film forming component. The “pigment” in the pigment component is further described herein, and is one that imparts a visual and/or performance effect. The pigment in the pigment component is distinguished from any pigments that may be included in the formulation of the film forming component.

As used herein, the term “plasticizer” refers to a material, such as organic liquids that are often colorless and nonvolatile, added to an otherwise brittle neat polymer (fractures or breaks without significant plastic deformation) or plastic rendering it softer, more flexible, to increase its plasticity, to decrease its viscosity, to increase its tack properties, and/or to decrease friction during its handling in manufacture.

As used herein the prefix “poly” refers to two or more. As a nonlimiting example, a polyisocyanate refers to a compound that includes two or more isocyanate groups and a polyol refers to a compound that includes two or more hydroxyl groups.

As used herein, the term “(poly) isocyanate” refers to blocked (or capped) (poly) isocyanates as well as unblocked (poly) isocyanates.

As used herein, the term “polymer” includes homopolymers (formed from one monomer) and copolymers that are formed from two or more different monomer reactants or that include two or more distinct repeat units. Further, the term “polymer” includes prepolymers, and oligomers. “Polymer” and “resin” may be used interchangeable herein.

As used herein, the term “powder coating” refers to a coating that is a free-flowing, dry powder typically applied electrostatically and then cured under heat or with ultraviolet light. The powder can include thermoplastic and/or thermoset polymers. The “gel-bake” state of a powder coating composition refers to the point during heating when the powder becomes liquid.

As used herein, the terms “primer” and “primer coat” refer to an undercoating layer that can be applied onto a substrate in order to prepare the surface for application of another coating layer.

As used herein, “reinforcing pigments” and like terms refer to particles that impart structural integrity, such as stiffness or strength, to a composition. Such particles can have many different shapes such as spherical, semi spherical, flake, rod, whisker and the like, and can include, for example, fiberglass, glass beads, and thermoplastic beads or particles.

As used herein, (retro) reflective and like terms refers to retroreflective or reflective. “Reflective” pigments or particles are those that reflect light specularly (i.e. at the same angle relative to the normal of the pigment surface, but an angle on the opposite side of the normal relative to the incident direction of the incident light), which can include for example metallic flake pigments, or are those that reflect or scatter light diffusely (in many directions), which can include, for example, titanium dioxide white pigments; “retroreflective” pigments or particles refer to those that return light back to the source and can include, for example, coated glass beads. “Luminescent pigments” are organic or inorganic compounds that absorb and emit energy as visible light when they are relatively cool.

As used herein, the terms “roughness average” or “Ra” refers to the smoothness of a surface as determined according to ISO method 4287-1997.

As used herein, “silicone” and like terms refers to polysiloxane polymers, which are based on a structure that includes alternate silicon and oxygen atoms. As used herein, “silicone” and “siloxane” are used interchangeably.

As used herein, the term “solvent borne coating” refers to coating compositions that use hydrocarbon solvents as a vehicle carrying the solid components, and that contain less than 40 wt % water based on the total carrier weight. The solvent borne coating can contain up to 80% of solid constituents dispersed and/or dissolved in the solvent.

As used herein, the term “substrate” refers to an article that may or may not have a previous coating layer formed thereon. This can include vehicle substrates, industrial substrates, structure substrates and the like. Examples of particular substrates include a structure, a vehicle, or industrial protective structure such as an electrical box enclosure, transformer housing, or motor control enclosure; a railcar container, tunnel, oil or gas industry component such as platforms, pipes, tanks, vessels, and their supports, marine component, automotive body part, aerospace component, pipeline, storage tank, or wind turbine component. “Structure” as used herein refers to a building, bridge, oil rig, oil platform, water tower, power line tower, support structures, wind turbines, walls, piers, docks, levees, dams, shipping containers, trailers, and any metal structure that is exposed to a corrosive environment. “Vehicle” refers to all types of vehicles, such as but not limited to cars, trucks, buses, tractors, harvesters, heavy duty equipment, vans, golf carts, motorcycles, bicycles, railcars, airplanes, helicopters, boats of all sizes and the like. Medical devices may be specifically excluded from the substrates of the present disclosure.

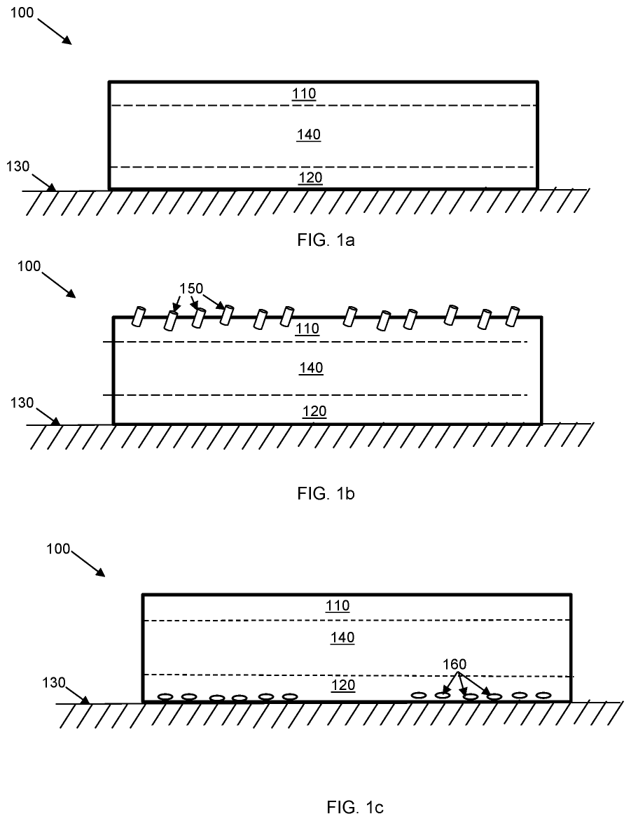

As used herein, the term “surface of the coating layer” refers to a portion of the coating layer, such as the outermost surface (see FIG. 1a-element 110) or innermost surface (see FIG. 1c, element 120), generally reflecting the top or bottom 20 vol. %, such as 15 vol. % or 10 vol. % of the hardened coating layer.

As used herein, the terms “total solids” or “solids” or “solids content” refers to the solids content as determined in accordance with ASTM D2369 (2015).

As used herein, the term “topcoat” refers to an uppermost coating layer and may be applied over another coating layer such as a basecoat to provide a protective and/or decorative layer.

As used herein, unless otherwise stated, the term “viscosity” refers to a value determined at 25° C. and ambient pressure and reflects a fluid's resistance to flow when subjected to a shear stress and/or a shear strain.

As used herein, the term “visual effect”, unless otherwise stated, refers to a color, a metallic appearance, a luminescent appearance, sparkle appearance, Flop Index, and/or a (retro) reflective effect imparted by a pigment, dye and/or particle and the like when embedded in a coating surface.

As used herein, the term “volatile” refers to materials that are readily vaporizable (easily evaporated) under use conditions. Non-volatile materials do not readily vaporize under use conditions.

As used herein, the term “waterborne coating composition” refers to a coating composition where the continuous phase includes 40% or greater water.

The present disclosure is directed to a hardened coating layer that includes a film forming component and a pigment component containing a pigment. The pigment component can be applied to at least a portion of a surface of the film forming component that is at least partially unhardened, such that the pigment becomes embedded in the film forming component. The pigment component does not itself form a film. Thus, the hardened coating layer of the present disclosure is a single coating layer in which pigments in the pigment component embed in the film forming component and, upon hardening or cure, become fixed. This is distinguished from a coating stack in which a first coating composition is deposited and a second coating composition including pigment is deposited on the first. Also, while the present disclosure can include application of additional coating layers, because the pigment particles embed in the film forming component, use of a topcoat or other means to hold the particles in place can be avoided. Accordingly, the present disclosure can exclude an additional layer deposited on the hardened coating layer.

The film forming component can be a powder coating composition, a solvent borne coating composition, a water borne coating composition, an anionic ecoat coating composition, a cationic ecoat coating composition, a coating composition including greater than 95 wt. % such as greater than 97 wt. % or from 95 wt. % to 100 wt. % total solids measured according to ASTM D2369 (2015), or a low temperature cure coating formulation. Any of the film forming components described herein can be a one-component composition. Alternatively, the film forming component can be a two-component or a multi-component composition where, as a nonlimiting example, a polymer or resin having crosslinkable groups and a crosslinking agent therefore are in separate components.

The film forming component can be a thermosetting coating composition and can include film-forming polymers or resins having functional groups that are reactive with either themselves (“self-crosslinking”) or a crosslinking agent. Suitable film-forming resins include, for example, acrylic polymers, polyester polymers, polyurethane polymers, polyamide polymers, polyether polymers, polysiloxane polymers, polyepoxy polymers, epoxy resins, vinyl resins, copolymers thereof, and mixtures thereof. Generally, these polymers can be any polymers of these types made by any method known to those skilled in the art. The functional groups on the film-forming resins can include, for example, carboxylic acid groups, amine groups, epoxide groups, hydroxyl groups, thiol groups, carbamate groups, amide groups, area groups, isocyanate groups (including blocked isocyanate groups), mercaptan groups, and combinations thereof. Mixtures of film-forming resins can also be used in the preparation of the present film forming component.

The film forming component can be a thermoplastic coating composition and can include film-forming polymers, such as thermoplastic olefins such as poly(meth)acrylates, polyethylene, polypropylene, polystyrene, polybutene, thermoplastic urethane, polycarbonate, acrylonitrile-based materials, or condensation polymers, nonlimiting examples including polyesters and polyamides such as nylon, and the like.

As shown in FIG. 1a, a cross-section of the hardened coating layer 100 of the present disclosure applied to a substrate (130) may be considered to have an outermost surface 110 including 20% or less, such as 15% or less or 10% or less of the volume of the hardened coating layer; an innermost surface 120, adjacent to substrate 130 including 20% or less, such as 15% or less or 10% or less of the volume of the hardened coating layer; innermost surface 120 and bulk 140 including the remainder.

When the pigment component is applied to the film forming component, the pigments in the pigment component become embedded in the film forming component, because the film forming component is at least partially unhardened. The pigments in the pigment component can be from 10 vol. % to 100 vol. %, such as from 20 vol. % to 100 vol. %, or 50 vol. % to 100 vol. % or 70 vol. % to 100 vol. % embedded in the film forming component, such as a surface of the film forming component, based on the volume of the pigment in the pigment component as determined by cross-section microscopy. FIG. 1b shows pigments 150 embedded in the outermost surface 110 of hardened coating layer 100. The pigments are shown in FIG. 1b as having various levels of embedment—some being more embedded than others. When pigments are positioned as shown in FIG. 1b, they can have an effect on the visual appearance of the hardened coating layer.

The pigment in the pigment component can make up less than 25 wt. %, such as less than 20 wt. % or less than 15 wt. % or less than 10 wt. % or from 1 to 25 wt. % of the weight of the hardened coating layer.

The pigment of the pigment component can be substantially uniformly distributed on a surface or a portion of a surface of the hardened coating layer and can provide a substantially uniform visual effect to the surface of the coating layer. As used in this context, “substantially” means that the visual effect will be uniform to the naked eye. The visual effect can, for example, be a metallic visual effect, a color effect, a luminous effect, and/or a (retro) reflective effect. The pigment can be substantially uniformly distributed on all of the surface (100%), most of the surface (99-50%), some of the surface (49-1%), and/or can be distributed in a predetermined pattern on the surface, where the surface may be the outermost surface (shown as 110 in FIG. 1). The pigment may be embedded in the hardened coating layer such that each pigment particle is surrounded by the film forming resin and therefore insulated from each other. Alternatively, the pigment particles can be in contact with each other, as a nonlimiting example, when electrical conductivity is desired.

Certain pigments, depending on the pigment component, the degree of “hardness” of the film forming component at the time the pigment component is applied, the method of application, type of film forming component, and the like, may result in the pigment (160) being situated at or near the innermost surface (120) of the hardened coating layer as shown in FIG. 1c. Particularly suitable may be effect pigments that offer some performance enhancement to the coating, such as corrosion inhibiting pigments. It could also be the case that the pigment in the pigment components becomes distributed throughout the entire hardened coating layer (now shown), including the surfaces (110, 120) and/or bulk (140) areas.

As noted above, the pigment component is applied prior to the film forming component being completely cured or hardened; that is “at least partially unhardened”. The pigment component can be applied when the film forming component is no more than 75%, such as no more than 65% or no more than 50% or from 0 to 75%, such as from 0 to 65% or from 0 to 50% of the cure/hardened potential of the film forming component.

Any type of pigment can be included in the pigment component. The pigment in the pigment component can include a visual effect pigment that results in a visual effect such as a color effect or imparting pigment, a metallic pigment, a luminescent pigment, a (retro) reflective pigment and/or particle and the like. The pigment can be a performance effect pigment that results in a particular performance characteristic, such as a corrosion inhibiting pigment, a radar reflective pigment, a LiDAR reflective pigment, an electrically conducting pigment, and/or a filler pigment. It will be appreciated that some pigments could impart both a visual and performance attribute to the hardened coating layer.

Suitable color imparting pigments are well known and include organic and/or inorganic materials, such as titanium dioxide, zinc oxide, iron oxide, carbon black, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), mono azo red, red iron oxide, quinacridone maroon, transparent red oxide, cobalt blue, iron blue, iron oxide yellow, chrome titanate, titanium yellow, nickel titanate yellow, transparent yellow oxide, lead chromate yellow, bismuth vanadium yellow, pre darkened chrome yellow, transparent red oxide chip, iron oxide red, molybdate orange, molybdate orange red, radar reflective pigments, LiDAR reflective pigments, corrosion inhibiting pigments, and combinations thereof.

Metallic pigments can be in any form, such as spherical, flake or pellet form, and can include, for example, aluminum, stainless steel, zinc, copper and alloys thereof and flakes thereof, interference pigments, such as titanium dioxide-coated mica, muscovite, phlogopite, or biotite, mica, gold, silver, nickel, platinum, bronze, brass, titanium, tungsten, including oxides and alloys thereof.

Luminescent pigments are commercially available, as are (retro) reflective particles, such as (retro) reflective microspheres.

The pigment in the pigment component can include an electrically conductive pigment, a radar reflective pigment or a LIDAR reflective pigment or an infrared reflective pigment. The LiDAR, radar reflective pigment or infrared reflective pigment can include, but is not limited to, nickel manganese ferrite blacks (Pigment Black 30), iron chromite brown-blacks (CI Pigment Green 17, CI Pigment Browns 29 and 35), Pigment Blue 28, Pigment Blue 36, Pigment Green 26, Pigment Green 50, Pigment Brown 33, Pigment Brown 24, Pigment Black 12 and Pigment Yellow 53 and combinations thereof. As indicated above, all of these materials are commercially available.

The pigments in the pigment component can include corrosion inhibiting pigments. Any suitable corrosion inhibiting pigment known in the art can be used including, for example, calcium strontium, zinc phosphosilicate; double orthophosphates, in which one of the cations is represented by zinc, nonlimiting examples being Zn—Al, Zn—Ca, Zn—K, Zn—Fe, Zn—Ca—Sr, Ba—Ca, Sr—Ca and combinations thereof; combinations of phosphate anion with anticorrosively efficient anions, nonlimiting examples being silicate, molybdate, and borate; modified phosphate pigments modified by organic corrosion inhibitors and combinations thereof. Nonlimiting examples of modified phosphate pigments include aluminum (III) zinc (II) phosphate, basic zinc phosphate, zinc phosphomolybdate, zinc calcium phosphomolybdate, zinc borophosphate, zinc strontium phosphosilicate, calcium barium phosphosilicate, calcium strontium zinc phosphosilicate, and combinations thereof. Other nonlimiting examples of corrosion inhibiting pigments that can be used in the coating formulation include zinc 5-nitroisophthalate, calcium 5-nitroisophthalate, calcium cyanurate, metal salts of dinonylnaphthalene sulfonic acids, and combinations thereof. Particularly suitable corrosion inhibiting pigments include magnesium oxide such as nano-sized magnesium oxide (5-100 nm), micron sized magnesium oxide (1-5 microns), silica, lithium salts such as lithium nitrate, lithium sulfate, lithium fluoride, lithium bromide, lithium chloride, lithium hydroxide, lithium carbonate, lithium iodide, or combinations of any of these.

The pigment in the pigment component can have a median particle size in the range of 2-75 μm, such as from 2-50 μm, 2-40 μm, 2-30 μm, 2-25 μm, 2-10 μm, 5-75 μm 5-50 μm, 5-40 μm, 5-30 μm, 5-25 μm, or 5-10 μm. Median particle size is measured or reported herein according to ISO 13320-1 (1999).

The pigment in the pigment component can make up from 0.1-100 wt. %, such as 1-90 wt. %, 1-75 wt. %, or 10-70 wt. % of the pigment component, with wt. % based on the total weight of the pigment component. The pigment can include 100% of the pigment component, such as dry pigment particles. The pigment component can be in the form of a slurry of the pigments in a suitable slurry medium. The slurry medium can be selected based on the type of pigment used, the type of film forming component the pigment component is to be applied to and/or the method of application of the pigment component. The pigment component can also be in the form of a “rinse” or “dip”. Nonlimiting examples of suitable media for forming the slurry or rinse include water; C₃-C₁₂ ketones, such as acetone, methyl ethyl ketone (MEK) and methyl isobutyl ketone (MIBK); alcohols, such as isopropanol, butanol and 2-ethyl hexanol; monomethyl, monoethyl and monohexyl ethers of ethylene glycol or propylene glycol, such as propylene gycol methyl ether; C₂-C₁₂ aldehydes, such as acetaldehyde, cinnamaldehyde, and vanillin; esters such as ethyl acetate, butyl acetate, phthalates, sebacates, adipates, terephthalates, dibenzoates, gluterates, or azelates; or any combinations thereof. “Slurry”, “spray”, “rinse” and “dip” may be used interchangeable herein, as all include pigment in a carrier; slurry typically refers to a higher solid content than rinse or dip.

The media or carrier (nonlimiting examples including MEK or MIBK) in the slurry, rinse, spray or dip may cause the uncured resin of an ecoat to swell. The swelling can aid pigment (such as aluminum flake or zinc dust) embedment. This can contribute to enhanced color affects in the outermost portion of the hardened coating layer when the pigment is one that imparts a visual effect.

The pigment used in the present pigment component may be one that is typically incompatible with certain coating compositions. Aluminum, silver, and zinc, for example, may hydrolyze or oxidize when used in aqueous e-coat compositions. According to the present disclosure, this is avoided, since the pigment is not dispersed in the film forming component or composition as in conventional formulations. As another nonlimiting example, if magnesium oxide is added directly to an aqueous electrodepositable coating composition it dissolves in the water in the composition and causes the pH in the bath to increase, causing the bath to become unstable. Due to this stability issue, magnesium oxide is unable to be incorporated directly into e-coat water based solutions. Another nonlimiting example of pigment “incompatibility” may be size related, such as when the pigment is too large to pass through certain nozzles. When pigments have a particle size greater than 5 μm, such as greater than 8 μm or greater than 10 μm, they may be too large to pass through certain nozzles as measured according to according to ISO 13320-1.

Two precision applicators can be used with the second having a nozzle with a larger orifice. As such, the film forming component can be precision applied using the first applicator and the pigment component applied using the second applicator. In this way the larger pigments can be precision applied to the at least partially unhardened film forming component.

The pigment component can be applied by any means known in the art, such as spraying, electrostatic spraying, rinsing, dipping, vibratory expulsion, screw conveyer, and/or auger. Alternatively, or in conjunction with any of these methods, the pigment component can be applied to the surface of a substrate onto which the film forming component has been applied. In this way, the pigment and/or particle in the pigment component becomes embedded in the film forming component as the coating is formed and the coating composition hardens. The pigment component can be applied in a predetermined pattern or shape. For example, the pigment component can be applied, just after application of the film forming component, using a stepper motor with a shaft attached to a pigment and/or particle reservoir. The rotational frequency of the motor can be used to control the amount of vibration and, as a result of the vibration, the mass flow rate of pigment component from the reservoir.

Another nonlimiting advantage of the present disclosure is the ability to achieve an effect, such as a visual effect, wherein the amount of pigment needed to achieve the effect can be markedly lower than the amount used in traditional formulations. When the film forming component includes a powder coating, the pigment component can be applied to the outermost surface of the powder coating. Upon hardening, the layer will have the color of the pigment. This avoids the traditional method of grinding pigment with all of the other powder coating components or dry blending pigment with the powder coating composition; thus, the present hardened coating layer uses less pigment and also may allow for more even distribution of the pigment and/or greater visual effect as compared to traditional powder coatings. Another nonlimiting particularly suitable application of the present disclosure is the application of the film forming component, such as an ecoat formulation, followed by application of the pigment component where the pigment includes a flake pigment, such as aluminum. This allows for better orientation of the flake, so less flake may be used to achieve a better visual effect.

The pigment component and/or the hardened coating layer may be substantially free (less than 3 weight %), essentially free (less than 1 weight %) and/or completely free of abrasion resistant particles, electrically conductive particles, reinforcing particles, (retro) reflective particles and/or magnetic particles.

The substrate to which a hardened coating layer according to this disclosure can be applied includes a wide range of substrates, including metal alloys, polymers, fiberglass, composites or combinations thereof. Such substrates can include a vehicle substrate, an industrial substrate a structural substrate and the like. The substrate can be in the form of a sheet, plate, bar, rod or any shape desired, and can be in the form of a vehicle part, such as a body, door, trunk lid, fender, hood or bumper. The thickness of the substrate can vary as desired. The substrate can include an adhesive layer that allows the substrate to be attached to another surface.

Vehicle parts typically formed from thermoplastic and thermoset materials include bumpers and trim.

Metallic substrates to which the coating layer components can be applied may include rigid metal substrates such as ferrous metals, aluminum, aluminum alloys, copper, and other metal and alloy substrates. The ferrous metal substrates can include iron, steel, and alloys thereof. Non-limiting examples of useful steel materials include cold rolled steel, galvanized (zinc coated) steel, electrogalvanized steel, stainless steel, pickled steel, zinc-iron alloys, and combinations thereof. Combinations or composites of ferrous and non-ferrous metals can also be used, such as hot-dipped galvanized steel assembled with aluminum substrates.

The coating layer can be applied directly to the metal substrate; “direct to metal” means there is no coating between the substrate and the coating layer of the present disclosure.

The direct to metal substrate can be a bare metal substrate, which is a virgin metal substrate that has not been treated with any pretreatment compositions such as conventional phosphating baths, heavy metal rinses, etc. Bare metal substrates that can be used herein can be a cut edge of a substrate that is otherwise treated and/or coated over the rest of its surface. Alternatively, the substrates can undergo treatment steps known in the art, such as cleaning, etching, pretreatment and the like, prior to the application of the film-forming component or hardened coating layer of the present disclosure. It will be understood by those skilled in the art that such treatments are not “coatings” and application of the present coating layer is still considered direct to metal.

When the film forming component is an electrocoat composition, the film forming component can be applied by optionally pretreating an electrical current collector or substrate; at least partially immersing the electrical current collector into a bath that includes the film forming component; and electrodepositing the film forming component onto a portion of the electrical current collector or substrate immersed in the bath.

After electrodeposition, the substrate can be dried for from 15 minutes to 1 hour (but not completely cured) after which the pigment component can be applied to the partially unhardened ecoat. When the pigment component is in powder form, it can be applied electrostatically, such as by using an electrostatic spray gun. When the pigment component is in a slurry form, it can be applied using a spray gun, brush or roller. Alternatively, the substrate can be immersed in a rinse including the pigment component or the rinse can be cascaded over the substrate. The substrate can then be baked, such as at 90 to 125° C., such as from 95 to 120° C. or from 100 to 115° C. for from 15 to 60 minutes, such as from 20 to 45 minutes or from 30 to 40 minutes.

When the film forming component is an electrocoat composition, the film forming component can include a pigment. The pigment can include an iron oxide, a lead oxide, strontium chromate, carbon black, coal dust, titanium dioxide, barium sulfate, a color pigment, a phyllosilicate pigment, a metal pigment, a thermally conductive, electrically insulative filler, fire-retardant pigment, or any combination thereof as described in International Patent Application No. PCT/US22/3497 at paragraphs [0051-0064] at levels described at paragraph [0086], the specific sections of which are incorporated herein by reference.

When the film forming component is an electrocoat composition, the film forming component can include pigments including inorganic, platelike pigments having an average equivalent spherical diameter of at least 0.2 microns and up to 5.0 microns as described in International Published Application WO 2019/243973 at paragraphs [0080-0081], the specific sections of which are incorporated herein by reference. Electrocoat compositions as described at paragraph of International Published Application WO 2019/126498, the specific section of which is incorporated herein by reference, can also be used.

When the film forming component is an electrocoat composition, the film forming component can include phyllosilicate pigments and dispersing agents as disclosed at paragraphs [0038-0050] of International Published Application WO 2021/127327, the specific sections of which are incorporated herein by reference.

When the film forming component is an electrocoat composition, the film forming component can be compatibilized with the pigment component to allow the pigment to embed more effectively. Acids can help solubilize cationic ecoat or other amine functional coatings and allow them to become more water dispersible or soluble. When the film forming component includes an anionic ecoat or acid functional coating, amines can allow the pigment to embed more effectively allow them to become more water dispersible or soluble.

When the film forming component is an electrocoat composition, the film forming component can include an active hydrogen-containing group and a cationic salt group and can be made cationic and water dispersible by at least partial neutralization with a resin neutralizing acid. Suitable resin neutralizing acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. The total amount of resin neutralizing acid used to neutralize the active hydrogen-containing, cationic salt groups in the film-forming component may be 20%, such as 35%, or 50%, or 60%, or 80% based on the total amines in the cationic salt group-containing film-forming component.

When the film forming component is an electrocoat composition, the film forming component can include an anionic polymer that can be, prior to or during dispersion in a dispersing medium that includes water, at least partially neutralized by, for example, treating with a base to form a water-dispersible anionic salt group-containing polymer. As used herein, the term “anionic salt group-containing polymer” refers to an anionic polymer that includes at least partially neutralized anionic functional groups, such as carboxylic acid and/or phosphoric acid groups, that impart a negative charge. Suitable bases include amines, such as, for example, tertiary amines. Nonlimiting examples of suitable amines include trialkylamines and dalkanolamines, such as triethylamine, diethylethanol amine and dimethylethanolamine. The total amount of resin neutralizing amine used to neutralize the anionic groups in the film-forming component may be 20%, such as 35%, or 50%, or 60%, or 80% based on the total carboxylic acid and/or phosphoric acid groups in the anionic group-containing film-forming component.

The hardened ecoat coating layer can have a dry film thickness of from 0.012 to 0.038 mm (0.5 to 1.5 mils), such as 0.015 to 0.036 mm (0.6 to 1.4 mils) or 0.016 to 0.033 mm (0.65 to 1.3 mils) determined using a Fischerscope MMS Permascope according to ASTM D7091-21.

When the film forming component is a powder coating composition, such as the powder coating that includes greater than 95 wt. % total solids measured according to ASTM D2369 (2015), the powder coating composition can be applied to the substrate by any means known in the art, such as electrostatic spraying. An electric potential of from 10 to 150 kV, such as 20 to 125 kV or 50 to 100 KV can be applied to the substrate with amperage restricted at from 1 to 20 mA, such as 2 to 17 mA or 5 to 15 mA and a flow rate of from 1 to 50 psi, such as 2 to 40 psi or 5 to 35 psi and atomization of from 1 to 50 psi, such as 2 to 40 psi or 5 to 35 psi. The resulting coated substrate can be baked at a temperature greater than the Tg of the powder coating composition for a period of time sufficient to achieve the “gel-bake” state. The pigment component can then be applied and the coating layer hardened, such as by heating. For example, the coated substrate can be baked at from 90 to 250° C., such as from 100 to 225° C. or from 120 to 215° C. for from 5 to 60 minutes, such as from 10 to 45 minutes or from 14 to 40 minutes. Alternatively, the pigment component can be applied prior to achieving the gel-bake state.

The dry film thickness of the hardened coating layer formed from the powder film former can range from 0.5 to 6 mils, such as 0.75 to 5 mils or 1 to 4 mils determined using a Fischerscope MMS Permascope according to ASTM D7091-21.

When the film forming component includes a waterborne coating composition (a waterborne coating) it can include an aqueous composition that includes a continuous phase including water, and a dispersed phase that includes a film-forming resin, an optional crosslinking agent, and optional additives as described herein. When the film forming component includes a solvent borne coating composition (a solvent borne coating) the solvent borne coating composition can include an organic solvent in which a film-forming resin, an optional crosslinking agent, and optional other additives as described herein are dissolved and/or dispersed. Liquid film forming components can be applied by any means known in the art, such as dipping, rolling, brushing, spraying and the like. Cure or hardening can be completed by any means known in the art, such as by heating, as needed depending on the chemistry of the film forming component used.

The dry film thickness of the hardened coating layers formed from liquid film forming components can be at least 0.5 μm, such as at least 1 μm, at least 2 μm, at least 5 μm and at least 7 μm and can be up to 65 μm, such as up to 60 μm, up to 55 μm, and up to 52 μm and from 0.5 μm to 60 μm, such as 0.5 μm to 65 μm, such as 0.5 μm to 60 μm, 0.5 μm to 55 μm, 0.5 μm to 52 μm, 1 μm to 65 μm, 1 μm to 60 μm, 1 μm to 55 μm, 5 μm to 65 μm, 5 μm to 60 μm and 5 μm to 55 μm determined using a Fischerscope MMS Permascope according to ASTM D7091-21. The dry film thickness can be any value or range between (and include) any of the values recited above.

The hardened coating layers described herein can be part of a multilayer coating, stack or system that includes one or more of a primer coat, a basecoat, a topcoat and a clearcoat. The hardened coating layer of the present disclosure can be deposited on top of and/or below other coating layers.

When the film forming component has appropriate rheological characteristics, it can be applied to a substrate using a precision applicator, followed by application of the pigment component, with optional removal of the pigment component applied to the substrate outside of a defined precision applicator application area. The pigment component may or may not be applied by precision application.

Appropriate rheological characteristics of the film forming component can include, as a nonlimiting example, a viscosity measured at 0.1 s⁻¹ (a low shear rate) and 25° C. that can be from 1,000 cps to 30,000 cps, such as 2,000 cps to 25,000 cps, 2,000 cps to 20,000 cps, and 3,000 cps to 15,000 cps, measured at 25° C. using an Anton Paar MCR 301 rheometer with a Double Gap Cylinder equipped with a DG26.7 measuring system. If the viscosity measured at 0.1 s⁻¹ of the coating composition is too high or too low, it may not properly flow through a precision applicator, separate streams may not merge as desired and/or the coating composition may sag unacceptably on vertical substrates. The viscosity measured at 0.1 s⁻¹ of the coating composition can be any value or range between (and include) any of the values recited above.

Appropriate rheological characteristics of the film forming component can alternatively include, as nonlimiting examples, a viscosity measured at 1000 s⁻¹ (a high shear rate, unless otherwise indicated, high shear rate refers to 1000 s⁻¹) at 25° C. that can be from 25 cps to 150 cps, 35 cps to 140 cps, 40 cps to 130 cps, and 50 cps to 125 cps, measured at 1000 s⁻¹, measured using an Anton Paar MCR 301 rheometer with a Double Gap Cylinder equipped with a DG26.7 measuring system. If the viscosity measured at 1000 s⁻¹ of the coating composition is too high or too low, it may not properly flow through a precision applicator, separate streams may not merge as desired and/or the coating composition may sag unacceptably on vertical substrates. The viscosity measured at 1000 s⁻¹ of the coating composition can be any value or range between (and include) any of the values recited above.

Appropriate rheological characteristics of the film forming component can alternatively include a shear thinning rheological profile, in other words, the viscosity of the coating composition is higher at low shear rates than the viscosity at high shear rates. The film forming component can have a viscosity measured at 0.1 s⁻¹ (low shear rate, unless otherwise indicated, low shear rate refers to 0.1 s⁻¹) that can be from 6 to 1,200, such as 20 to 1,000, 30 to 750, or 40 to 1,200 times higher than the viscosity of the coating composition measured at 1000 s⁻¹ (high shear rate), referred to as the viscosity ratio, measured using an Anton Paar MCR 301 rheometer at 25° C. with a Double Gap Cylinder equipped with a DG26.7 measuring system. If the shear thinning property of the coating composition is too high or too low, it may not properly flow through a precision applicator, separate streams may not merge as desired and/or the coating composition may sag unacceptably on vertical substrates. The shear thinning property of the coating composition can be any value or range between (and include) any of the values recited above.

The film forming component can include various other additives, such as additional binders, carriers, water, catalysts, conventional additives, or combinations thereof. Conventional additives can include, but are not limited to, dispersants, antioxidants, and absorbers, wetting agents, leveling agents, antifoaming agents, anti-cratering agents, thermoplastic resins, plasticizers, abrasion resistant particles, fillers and including, but not limited to, micas, talc, clays, and inorganic minerals, metal oxides, metal flake and various forms of carbon, anti-oxidants, hindered amine light stabilizers, UV light absorbers and stabilizers, surfactants, flow and surface control agents, thixotropic agents, rheology modifying agents, reactive diluents, catalysts, reaction inhibitors, corrosion-inhibitors, other customary auxiliaries and combinations thereof. As noted above, the film forming component can itself include pigment, which may be the same or different from the pigment in the pigment component.

The hardened coating layers described herein can impart improved corrosion resistance to a substrate as compared to a coating having the same pigment included in the film forming component itself. Particularly suitable pigments in the pigment component for imparting corrosion resistance can include magnesium oxide, zinc, silver, mica, aluminum, and combinations thereof.

The hardened coating layers described herein can have improved color as compared to a coating having the same pigment included in the film forming component at the same loading based on total composition weight. For example, the pigment in the pigment component can be a flake pigment and provide a stronger metallic brilliance, the color can be more uniform and/or the color can be brighter. The color properties can be measured using a BYK-Mac I metallic color spectrophotometer instrument manufactured by BYK-Gardner. When a hardened coating layer is formed according to the present disclosure using a powder film-forming component, the brightness as indicated by the luminance at 15° (L*_{15°}) of the hardened coating layer, such as when applied to a substrate, can be greater than 55, such as greater than 75 or range from 55 to 95, such as from 75 to 92 or from 78 to 91. This is a significant achievement, as the L*_{15°} for conventional powder coatings is typically around 50 or lower. The present disclosure may be used for achieving L*_{15°} values with powder coating that have previously only been achieved with liquid coatings.

The hardened coating layers described herein can have a measurable flop index. The flop index can be measured using a BYK-Mac I Spectrophotometer of BYK Co. Specifically, the flop index can be calculated by measuring the luminance of reflected light at angles of 15°, 45°, and 110° with respect to the surface of the hardened coating, and then substituting these values into Equation 1:

$$Flop Index = \frac{2.69 {( {L}_{15 °}^{*} - {L}_{110 °}^{*} )}^{1.11}}{{( {L}_{45 °}^{*} )}^{0.86}} \qquad Equation 1$$

$${L}_{15 °}^{*} = luminance of the reflected light measured at an angle of 15 °$$

$${L}_{45 °}^{*} = luminance of the reflected light measured at an angle of 45 °$$

$${L}_{110 °}^{*} = luminance of the reflected light measured at an angle of 110 °$$

The flop index of the object surface without metallic texture is zero.

The hardened coating layers described herein can have a flop index of greater than 8, such as greater than 10 or from 8 to 22, such as from 10 to 20 or from 8 to 15 measured as described above.

The hardened coating layers described herein can form a smooth coating layer or film. “Smooth” as used herein, means having a roughness average, Ra, of less than 5 μm, such as less than 3 μm, less than 1.8 μm, less than 1 μm or less than 0.5 μm, as measured according to ISO method 4287-1997.

It should be understood that, where not mutually exclusive, the various features of the present disclosure described, shown and/or claimed herein may be used in combination with each other. In addition, the following examples are presented to demonstrate the general principles coating layers and coated substrates provided by the present disclosure. All amounts listed are described in parts by weight, unless otherwise indicated. The disclosure should not be considered as limited to the specific Examples presented.

### EXAMPLES

### Example 1 (Galvanic Protection Via Zinc Dust)

CRS substrate obtained from ACT Industries was evaluated. 4″ by 12″ panels were treated using the spray application of Chemkleen surface prep 1, an alkaline cleaner commercially available from PPG Industries, Inc. Panels were spray cleaned and degreased for 120 seconds at 10-15 psi in ST-1 (125° F.) using Vee-jet nozzles and rinsed with deionized water by immersing in a deionized water bath (75° F.) for 30 seconds followed by a deionized water spray rinse using a Melnor Rear-Trigger 7-Pattern nozzle set to shower mode (available from Home Depot).

After spray cleaning and degreasing, panels were rinsed by a deionized water spray rinse using a Melnor Rear-Trigger 7-Pattern nozzle set to shower mode (75° F.) for 30 seconds, and warm air dried using a Hi-Velocity handheld blow-dryer made by OSTER (model number 078302-300-000) on high-setting at a temperature of about 50-55° C. until the panel was dry (about 1-5 minutes). Panels were cut to 4″ by 6″ size using a panel cutter.

The 4″ by 6″ CRS panels were immersed into a bath containing CR840, a cationic electrocoat commercially available from PPG, diluted with water to 20% theoretical solids non-volatile weight. The bath temperature was 90° F. and the panel served as the cathode in electrical communication with a counter-anode. The coating composition was electrodeposited onto the panel when an electrical potential of 200 volts, with a current limit of 5 amperes, was impressed between the electrodes. Coat out was limited at 36° C. The coated panel was allowed to dry (ambient conditions for 1-2 hours) and a suspension of 25 grams of zinc dust (Ultra-Pure Zinc Dust UP6 from Purity zinc metals) in 250 grams of methoxy propanol, a glycol ether solvent (available as Dowanol PM from the Dow Chemical Company) was then sprayed onto the film. Following application of the zinc spray, the panel was allowed to dry for about 5-10 minutes at ambient conditions before it was baked for 30 minutes at 177° C. in an electric oven. A smooth film (ISO method 4287-1997) having a film build of approximately 19 microns was achieved.

Galvanic protection was evaluated by monitoring the development of white rust (i.e., zinc corrosion product) under 500-hour salt spray testing according to ASTM B 117 (2019). Galvanic protection was assessed as white rust on the face, scribe, and, if applicable, gravel impact marks of the coated panels. White rust indicates that the zinc rich coating oxidized in a sacrificial way to protect the base metal of the substrate. Red rust indicates oxidation of the substrate.

Results following the salt spray test, as determined visually, indicated that white rust dominated along the scribe with little red rust detected.

### Example 2 (Aluminum Particle Embedment)

A commercially available cationic acrylic e-coat from PPG, POWERCRON 935, was applied via an electrodeposition process to cold rolled steel panels (ACT part number 26241) as described in Example 1. Control samples were baked directly after the electrodeposition at 177° C. for 30 minutes.

Pigment components in slurry form were applied to the partial unhardended ecoat film. Slurries were prepared by mixing 15 grams of an aluminum pigment (HYDROLAN 2153, from Eckart) and 150 grams of methyl ethyl ketone. The slurries were sprayed using a standard liquid paint gun (Binks 2100 spray gun) directly on top of the vertically hung panels. The panels were sprayed within 30 minutes after the electrodeposition process. Samples were then baked at 177° C. for 30 minutes. Panels were then cut down to 2.5″×1.75″ and placed in a Weather-Ometer using ASTM D7869-13 settings. The gloss retention is reported in Table 1. Example A was a control without aluminum embedded, Example B was the panel with aluminum as described above. The gloss retention was higher for the panels where the aluminum was embedded.

TABLE 1
Gloss retention for acrylic e-coat

| | | | % 20 gloss | % 60 gloss |
|---|---|---|---|---|
| | | | retention | retention |
| Sample | 20° gloss | 60° gloss | (1000 hrs) | (1000 hrs) |
| Example A | 75.2 | 90.5 | 39.6 | 73.1 |
| Example B | 46.0 | 79.8 | 97.6 | 93.7 |

### Example 3: Acrylic E-Coat for Corrosion

A commercially available cationic acrylic e-coat from PPG, CR 935, was applied via an electrodeposition process to cold rolled steel panels (ACT part number 26241) and baked at 177° C. for 30 minutes.

Panels were prepared as described in example 1 and were then sprayed with a silver mica slurries prepared by mixing 15 grams of silver mica pigment (Mearlin Sparkle 139X from BASF) and 150 grams of methyl ethyl ketone and sprayed using a standard liquid paint gun (a 3M Accuspray gun with 1.2 mm nozzle side) directly on top of the unhardened electrocoat panels. The panels were sprayed within 30 minutes after the electrodeposition process. Samples were then baked at 177° C. for 30 minutes (Example C was a control without application of mica pigment, Example D includes application of mica pigment as described).

The substrates were evaluated for scribe corrosion after 500-hour salt spray testing according to ASTM B 117 (2019). An improvement in scribe corrosion was observed as shown in Table 2, where the smaller number indicates improvement.

TABLE 2

| | | Scribe Creep |
|---|---|---|
| Samples | Coating | (mm) |
| Example C | Electrocoat | 10.0 |
| Example D | Electrocoat with | 5.1 |
| | silver mica | |
| | slurry | |

### Example 4: Electrodepositable Coating Composition

An electrodepositable coating composition was prepared similar to that described in examples 4, 5A and 5B in U.S. Pat. No. 10,947,408.

Powder MgO particle Embedment in Anionic Electrocoat

An electrodepositable coating composition (similar to example 5B in U.S. Pat. No. 10,947,408) was electrodeposited onto 2024 T3 bare aluminum alloy test panels (ACT Test Panel Technologies) with a current of 0.2 amps and voltage of 130 V for 90 seconds at a bath temperature of 85° F. achieving a dry film thickness of 0.51±0.02 mils (example E, Table 3) using a Positector 6000 permascope according to ASTM D7091-21. After electrodeposition, the panels were dried for 15 minutes to 1 hour. Powdered magnesium oxide particle (MAGCHEM 10-325) was added to a fluidized feed hopper (Nordson HR-1-4) and fluidized with clean dry air. The powder was then electrostatically applied (via Nordson Encore electrostatic spray gun) to a vertical grounded test panel at 75 kV at a flow rate of 30 psi and atomization of 30 psi (example F, Table 3). The panels were then baked in an electric oven at 225° F. for 30 minutes. The panels had a dry film thickness of 0.70±0.07 mils using a Positector 6000 permascope according to ASTM D7091-21.

After the panels were baked, they were scribed with a 10 cm by 10 cm “X” that was scribed into the panel surface to a sufficient depth to penetrate any surface coating and to expose the underlying metal. Scribed test panels were then placed into a 5% sodium chloride neutral salt spray cabinet according to ASTM B117 (2019) (with the exception that the pH & salt concentration checked weekly as opposed to daily). The test panels were evaluated after 504 hours neutral salt fog exposure according to the ratings shown in Table 3. The panels were rated according to the following scale for scribe corrosion with a rating scale of 0 to 100, the number represents the percent of scribe area showing visible corrosion with lower numbers indicating less corrosion and, therefore, better corrosion inhibition. The shine of the scribe was also evaluated on a rating scale of 0 to 100 representing the percent of the scribe, that is dark or tarnished. Both values are the average of two replicates. The lower the number, the better the performance.

TABLE 3
Powder Salt Spray Performance

| | Panel Coating | Scribe Corrosion | Scribe Shine |
|---|---|---|---|
| Example E | Unhibited Electrocoat | 60 | 85 |
| | only | | |
| Example F | Unhibited Electrocoat | 2 | 30 |
| | with MgO¹ embedded | | |

¹Magchem 10-325, available from Martin Marietta Magnesia Specialties

As can be seen, there is a large improvement in scribe corrosion and scribe shine with Example F, when MgO particles were embedded in the surface, as compared to Example E, with no MgO embedded. As noted in the specification, direct incorporation of MgO particles into a water borne ecoat bath is not generally achievable and so no comparison with MgO directly added to the ecoat composition could be made. The present disclosure allows for use of MgO with waterborne ecoat.

### Example 5: Liquid MgO Slurry Embedment in Anionic Electrocoat

The electrodepositable coating composition of Example 4 was electrodeposited onto T3 bare aluminum alloy test panels, (ACT Test Panel Technologies described above), with a current of 0.2 amps and voltage 170 V for 90 seconds at a bath temperature of 85° F. achieve a dry film thickness of 0.93±0.04 mils (Example G, Table 4) determined according to ASTM D7091-21. The panels were dried for 15 minutes to 1 hour and then a slurry was applied. The slurry included 10% (by weight) of Magnesium oxide particles (MagCHEM 10-325) in acetone, which was agitated with a tongue depressor prior to spray. The slurry was spray applied with an HVLP spray gun onto vertical electrocoated test panels with 2 passes (2 Pass, Example H, Table 4), or with 4 passes (4 Pass, Example I, Table 4). Upon hardening, the dry film thicknesses of the hardened coating layer was 1.03 mil and 0.75 mil, respectively determined according to ASTM D7091-21.

The panels were baked in an electric oven at 225° F. for 30 minutes. After baking, they were inscribed with a 10 cm by 10 cm “X” that was scribed into the panel surface to a sufficient depth to penetrate any surface coating and to expose the underlying metal. Scribed test panels were then placed into a 5% sodium chloride neutral salt spray cabinet according to ASTM B117 (2019) (with the exception that the pH & salt concentration checked weekly as opposed to daily). The test panels were evaluated after 504 hours neutral salt fog exposure according to the ratings shown in Table 5 below. The panels were rated as described in example 4.

TABLE 5
Slurry Salt Spray Performance

| | Panel Coating | Scribe Corrosion | Scribe Shine |
|---|---|---|---|
| Example G | Uninhibited Electrocoat | 60 | 85 |
| Example H | Uninhibited Electrocoat | 2 | 45 |
| | with 2 Pass MgO⁶ | | |
| | Slurry | | |
| Example I | Uninhibited Electrocoat | 1 | 35 |
| | with 4 Pass MgO¹ | | |
| | Slurry | | |

¹Magchem ® 10-325, available from Martin Marietta Magnesia Specialties

Minimal corrosion (<5 percent) was observed with the panels to which the MgO slurry was applied (Examples H and I), compared to over 50 percent corrosion with the control (Example G).

### Example 6: Epoxy E-Coat for Corrosion

A CRS substrate from ACT Industries was evaluated. 4″ by 12″ panels were treated using the spray application of Chemkleen Surface Prep 1, an alkaline cleaner commercially available from PPG Industries, Inc. The panels were spray cleaned and degreased for 120 seconds at 10-15 psi in ST-1 (125° F.) using Vee-jet nozzles and rinsed with deionized water by immersing in a deionized water bath (75° F.) for 30 seconds followed by a deionized water spray rinse using a Melnor Rear-Trigger 7-Pattern nozzle set to shower mode (available from Home Depot).

After spray cleaning and degreasing (but no pretreatment), the panels were rinsed with a deionized water spray rinse using a Melnor Rear-Trigger 7-Pattern nozzle set to shower mode (75° F.) for 30 seconds, and warm air dried using a Hi-Velocity handheld blow-dryer made by OSTER (model number 078302-300-000) on high-setting at a temperature of about 50-55° C. until the panel was dry (about 1-5 minutes).

A commercially available epoxy e-coat from PPG, FrameCoat II, was applied using the electrodeposition process described above. Control samples were baked directly after the electrodeposition process at 177° C. for 25 minutes (Example J). Panels prepared according to the present disclosure were sprayed with an aluminum slurry prepared by mixing 15 grams of aluminum pigment (HYDROLAN 2153) in methyl ethyl ketone and applied to the panels before baking at 177° C. for 25 minutes (Example K).

The substrates were evaluated for scribe corrosion by scribing the surface and testing them under 500-hours using salt spray testing according to ASTM B 117 (2019). Results are shown in Table 6.

In addition, flexibility was evaluated per ASTM D522 (2010) with a 180° bend over 1/″ mandrel. No visual cracking or delamination of the films was observed. After measuring film thickness, cure was evaluated by double acetone rub testing. The baked panels were rubbed with an acetone soaked WYPALL X80 disposable paper wipe manufactured by Kimberly-Clark. The rubs were counted as a double rub (one rub forward and rub backward constitutes a double rub). Rubs were continued until either 50 rubs were counted or a visible scratch/mar was observed. In both samples over 50 rubs were achieved without any scratch/mar being observed. Scribe corrosion, however, was much improved when the pigment component was applied.

TABLE 6

| | | Scribe Creep | Double Rub |
|---|---|---|---|
| | Coating | (mm) | Data |
| Example J | Ecoat | 12.0 | >50 |
| Example K | Ecoat with | 5.0 | >50 |
| | Aluminum | | |
| | Slurry | | |

### Examples 7-13 (Powder Coating)

Panels were coated with a commercial PPG black hybrid powder primer, product code PCF 90202 only, the powder primer dry blended with the pigment component (“Dry Blend”), or the powder primer followed by the pigment component according to the disclosures herein. The pigment used was either XIRALLIC pigment, available from Merck, or MEARLIN 139X available from Sun Chemical, as indicated in Table 7.

The PCF 90202 conventional powder was sprayed electrostatically by adding the powder to an application cup and applied electrostatically (via Encore LT Manual electrostatic spray gun) to grounded cold rolled steel panels (ACT part number 26241) at 75 kV at a flow rate of 10 psi and atomization of 10 psi. The dry blend sample was prepared by combining the pigment indicated in Table 7 with the base powder in a bag or mixing cup at a level required to achieve the pigment loading also shown in Table 7. The container was then shaken vigorously for three minutes to thoroughly mix the pigment in the base powder and the dry blend applied using the same electrostatic procedure described above. For panels prepared according to the present disclosure the pigment component was directly sprayed on top of the PCF 90202 using an Encore LT Manual electrostatic spray gun settings of 75 kV at a flow rate of 30 psi and atomization of 30 psi (identified as “Embedded” in Table 7). The loading of pigment for these panels was calculated based on the weight deposited. Specifically, the weight of the powder was measured just after applying the PCF-90202 and then again after application of the pigment component (powder coated panel subtracting off the panel's initial weight).

Directly after application, all of the panels were baked in an electric oven at 191° C. for 20 minutes and resulted in a cured film thickness of approximately 3 mils. Cured films were evaluated for color using a BYK-Mac I metallic color spectrophotometer instrument manufactured by BYK-Gardner.

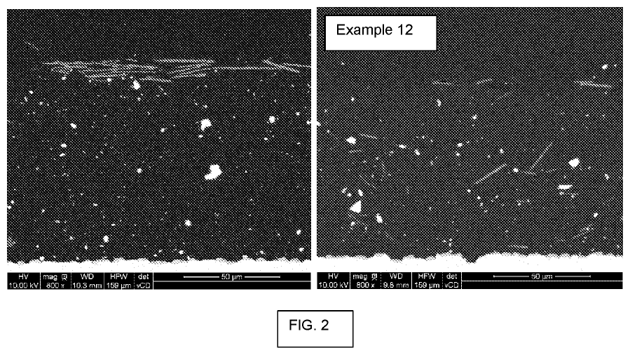

The L* data for panels is provided in Table 7. All of the panels prepared according to the present disclosure, relative to the other panels, had a much higher level of brightness as is seen at all angles as indicated by the higher L* values. This is indicative of the pigment having greater brilliance relative to the dark base, because the pigment is concentrated at the surface of the coating layer. SEM Cross-sections of examples 12 and 13 are shown in FIG. 2 to highlight the local concentration of the pigment. The SEM samples were prepared by mounting samples into an epoxy film and microtoming the film. The samples were then coated with Au/Pd for 40 seconds and analyzed in the Quanta 250 FEG SEM under high vacuum.

TABLE 7
BYK Mac data

| | | | Pigment | | | | | | |
|---|---|---|---|---|---|---|---|---|---|
| | | | Loading | | | | | | |
| | | | (wt % of | | | | | | |
| Example | | | total | | | | | | |
| number | Method | Pigment | formulation) | L*_{-15°} | L*_{15°} | L*_{25°} | L*_{45°} | L*_{75°} | L*_{110°} |
| 7 | Base powder | None | 0 | 13.7 | 8.8 | 4.2 | 3.1 | 3.5 | 3.4 |
| 8 | Dry Blend | Merck | 2.4 | 51.0 | 42.0 | 21.3 | 7.2 | 5.0 | 4.5 |
| | (comparative) | Xirallic | | | | | | | |
| 9 | Embedded | Merck | 2.4 | 89.0 | 78.7 | 52.2 | 25.8 | 13.7 | 9.9 |
| | | Xirallic | | | | | | | |
| 10 | Dry Blend | Merck | 2.5 | 60.4 | 50.4 | 27.0 | 9.6 | 5.9 | 5.1 |
| | (comparative) | Xirallic | | | | | | | |
| 11 | Embedded | Merck | 2.5 | 100.7 | 90.4 | 63.3 | 34.5 | 19.2 | 13.4 |
| | | Xirallic | | | | | | | |
| 12 | Dry Blend | Mearlin | 4.2 | 48.1 | 41.5 | 26.4 | 12.0 | 6.6 | 5.0 |
| | (comparative) | 139X | | | | | | | |
| 13 | Embedded | Mearlin | 4.2 | 92.2 | 84.9 | 58.4 | 28.6 | 14.9 | 10.2 |
| | | 139X | | | | | | | |

The use of the hardened coating layer of the present disclosure opens new color space for powder coatings as indicated by the higher L* values (brightness) compared to those where the pigment is mixed with the other coating components.

### Examples 14-17

Panels were coated with a commercial PPG powder coating as indicated in Table 8 followed by the indicated pigment component. The powder coating was applied electrostatically (via Encore LT Manual electrostatic spray gun) to grounded cold rolled steel panels (ACT part number 26241) at 75 kV at a flow rate of 10 psi and atomization of 10 psi. The pigment component (dry pigment) was directly sprayed on top of the powder coating using an Encore LT Manual electrostatic spray gun with settings of 75 kV at a flow rate of 30 psi and atomization of 30 psi, the panels were baked in an electric oven at 191° C. for 20 minutes and dry film thickness of approximately 3 mils determined according to ASTM D7091-21. The cured films were evaluated for smoothness using a handheld Mitutoyo sj-210 (Mitutoyo America Corporation) with a cut-off wavelength of 0.8 mm according to ISO method 4287-1997. The results are shown in Table 8, where “Ra” “roughness average”; these values represent the average of three panels.

TABLE 8

| | Powder | | Roughness |
|---|---|---|---|
| Example | Coating | Pigment | Average (Ra) |
| 14 | PCT 80352² | XIRALLIC T60-10³ | 1.39 |
| 15 | PCT 69106² | 158062 Xirallic ® T60-23 | 0.26 |
| | | SW Galaxy Blue³ | |
| 16 | PCT 99125² | Mearlin Bright White | 0.25 |
| | | 139X-Ext⁴ | |
| 17 | PCT 99125² | Mearlin Bright White 139P⁴ | 0.35 |

²available from PPG
³available from Merck kGaA
⁴available from Sun Chemical

As the data show, example 14 had a relatively rough or “brushed” surface, example 17 had a less rough or “sanitary” finish, while examples 15 and 16 had a smooth or “flawless” finish.

### Examples 18 and 19

A commercially available film forming component epoxy e-coat from PPG, FrameCoat II, was applied using the electrodeposition process described above on grounded cold rolled steel panels (ACT part number 26241). Pigment component slurries were prepared by mixing 15 grams of aluminum pigment (Sparkle silver 3122-AR, Silberline Manufacturing Co., Inc.) in 150 grams of either methyl ethyl ketone or acetone. The slurries were sprayed using a standard liquid paint gun (a 3M Accuspray gun with 1.2 mm nozzle side) directly on top of the unhardened electrocoated panels. The panels were sprayed within 30 minutes after the electrodeposition process. Samples were then baked at 177° C. for 30 minutes. The results are shown in Table 9.

TABLE 9

| | | | Roughness |
|---|---|---|---|
| Example | Effect Pigment | Slurry Medium | Average (Ra) |
| 18 | Sparkle silver 3122-AR¹⁵ | Methyl ethyl | 1.66 |
| | | ketone | |
| 19 | Sparkle silver 3122-AR¹⁵ | Acetone | 2.78 |

¹⁵available from Silberline Manufacturing Co., Inc.

As the data show, Examples 18 and 19 would be considered to have a somewhat smooth finish.

### Examples 20-23 (Precision Application)

The nozzles used for precision application can clog when traditional effect pigments are included in precision coating compositions. Thus, precision coatings are limited to base colors only (i.e. no effect pigment).

An electrocoat primed substrate was coated with a color base layer as indicated in Table 10 and was cured or dried as indicated in Table 10. A second coating as indicated in Table 10 was applied via precision applicator over an area of 3×3 inch [7.6×7.6 cm] square at a dry film thickness of 30-80 μm determined according to ASTM D7091-21. An effect pigment as indicated in Table 10 was electrostatically powder spray applied to the coating that had been precision applied but was not yet cured. In this manner the effect pigment was applied to only the uncured precision applied coating. The samples were then allowed a period of ambient post cure or heated flash time. Any remaining pigment was removed by means of air knife, feather duster or other non-destructive method. Upon satisfactory removal of unadhered pigment, the sample was clear coated and cured as indicated in Table 10.

TABLE 10

| Example | 22 | 23 | 24 | 25 |
|---|---|---|---|---|
| Substrate | ED6280C²⁰ | ED6280C²⁰ | ED6280C²⁰ | ED6280C²⁰ |
| Spray | DMD1648 | HSM40 | T400 | T471 |
| Applied | Deltron | White¹⁷ | Envirobase | Envirobase |
| Coating 1 | White¹⁶ | | White¹⁸ | Silver |
| | | | | Metallic¹⁸ |
| Coating 1 | 30 minutes | 30 minutes | 30 minutes | 30 minutes |
| Cure | at 60° C. | at 140° C. | at 60° C. | at 60° C. |
| Precision | DBC9700 | DBC9700 | T414 | T414 |
| Applied | Deltron | Deltron | Envirobase | Envirobase |
| Coating | Black¹⁶ | Black¹⁶ | Blue¹⁸ | Blue¹⁸ |
| Powder | Mearlin EXT | Mearlin EXT | Mearlin EXT | Mearlin EXT |
| Applied | Sparkle | Sparkle | Sparkle | Sparkle 139X¹⁹ |
| Effect | 139X¹⁹ | 139X¹⁹ | 139X¹⁹ | |
| Pigment | | | | |
| Clearcoat | DC4000 | DC4000 | DC4000 | DC4000 |
| | Deltron | Deltron | Deltron | Deltron |
| | Clearcoat¹⁶ | Clearcoat¹⁶ | Clearcoat¹⁶ | Clearcoat¹⁶ |
| Clearcoat | 30 minutes | 30 minutes | 30 minutes | 30 minutes |
| cure | at 60° C. | at 60° C. | at 60° C. | at 60° C. |

¹⁶Deltron coatings available from PPG
¹⁷available from PPG
¹⁸Envirobase coatings available from PPG
¹⁹available from Sun Chemical
²⁰steel panels coated with ED6280C available from PPG

The method according to the present disclosure allowed for effect pigment to be placed only on a specific portion of a coated panel (that portion to which the coating was precision applied). This represents an advance over conventional methods in which effect pigment is added to the entire formulation; a reduced amount of effect pigment can be used according to the present disclosure and the effect pigment was better aligned at the surface of the coating. Thus, using the single coating composition and methods described herein, effect pigments were successfully incorporated into precision applied coatings, which were not previously attainable.

Whereas particular embodiments of this disclosure have been described above for purposes of illustration, it will be evident to those skilled in the art that numerous variations of the details of the present disclosure can be made without departing from what is defined in the appended claims.

1. A hardened coating layer comprising:
a. a film forming component; and
b. a pigment component comprising a pigment;
wherein the pigment component is applied to at least a portion of a surface of the film forming component that is at least partially unhardened when the pigment component is applied, such that the pigment becomes embedded in the film forming component;
wherein the pigment component does not itself form a film.

2. The hardened coating layer according to claim 1 formed by:
a. applying the film forming component to at least a portion of a substrate;
b. applying the pigment component comprising a pigment to at least a portion of a surface of the film forming component that is at least partially unhardened when the pigment component is applied, such that pigment becomes embedded in the film forming component; and
c. hardening the coating layer;
wherein the pigment component does not itself form a film.

3. The coating layer of claim 1, wherein the pigment in the pigment component is incompatible with the film forming component and/or incompatible with a desired application method.

4. The coating layer of claim 1, wherein the pigment is concentrated in a portion of the coating layer making up 75 wt. % of a surface of the coating layer.

5. The coating layer of claim 1, wherein the pigment is substantially uniformly distributed on a surface or a portion of a surface of the coating layer and provides a substantially uniform visual effect to the surface of the coating layer.

6. The coating layer of claim 1, wherein the pigment of the pigment component comprises less than 25 wt. % of the weight of the hardened coating layer.

7. The coating layer of claim 1, wherein the pigment component comprises dry pigment particles, a slurry of pigment particles and/or a liquid carrier, or a rinse or dip comprising pigment particles dispersed in a carrier
And optionally wherein the carrier comprises water; C₃-C₁₂ ketones; monomethyl, monoethyl or monohexyl ethers of ethylene glycol or propylene glycol; C₂-C₁₂ aldehydes; esters; or any combinations thereof.

8. (canceled)

9. The coating layer of claim 1, wherein the pigment is embedded in the coating layer such that from 10 vol. % to 100 vol. % of the pigment is embedded in the coating layer, based on the volume of the pigment, as determined by cross-section microscopy.

10. The coating layer of claim 1, wherein the pigment has a visual effect and/or a performance effect, wherein the visual effect and/or performance effect comprises embedding a corrosion inhibiting pigment, a color imparting pigment, a metallic pigment, a radar reflective pigment, a LIDAR reflective pigment, a filler pigment, a luminescent pigment, a (retro) reflective pigment, a reinforcing particle, or combinations thereof in the film forming component, wherein the metallic effect pigments are in spherical, flake and/or pellet form, wherein the metallic effect pigments comprise aluminum, stainless steel, zinc, copper and alloys thereof and flakes thereof, and wherein the interference pigments comprise titanium dioxide-coated mica, muscovite, phlogopite or biotite, mica, gold, silver, nickel, platinum, bronze, brass, titanium, tungsten, including oxides and alloys thereof.

11. The coating layer of claim 1, wherein the pigment and/or hardened coating layer is substantially free of abrasion resistant particles, electrically conductive particles, reinforcing particles, (retro) reflective particles, and/or magnetic particles, and, when the film forming component is thermoplastic.

12. The coating layer of claim 1, wherein the pigment component comprises a corrosion inhibiting pigment comprising nano-sized magnesium oxide (5-100 nm determined according to ISO 13320-1 (1999)), micron sized magnesium oxide (1-5 microns determined according to ISO 13320-1 (1999)), silica,
lithium nitrate, lithium sulfate, lithium fluoride, lithium bromide,
lithium chloride, lithium hydroxide, lithium carbonate, lithium iodide, or combinations of any of these.

13. The coating layer of claim 1, wherein the film forming component comprises a thermoset resin, a thermoplastic resin, a crosslinkable resin and crosslinker therefor, a self crosslinking resin, or any combination thereof and wherein the film forming component comprises one component or multiple components or
wherein the film forming component comprises a powder coating composition, a solvent borne coating composition, a water borne coating composition, an anionic ecoat coating composition, a cationic ecoat coating composition, a coating composition comprising greater than 95 wt. % total solids measured according to ASTM D2369 (2015), or a low temperature cure coating formulation.

14. (canceled)

15. The coating layer of claim 1, wherein the at least partially unhardened film forming component is hardened from 0 to 75% of its hardening potential when the pigment component is applied.

16. The coating layer of claim 1, wherein the film forming component comprises a powder coating composition, which may be in a gel-bake state when the pigment component is applied and, upon hardening, provides a substantially uniform effect to the outermost surface of the coating layer or a portion thereof, wherein the uniform effect comprises a color effect and/or a metallic effect.

17. The coating layer of claim 16, wherein the coating layer comprises a flake pigment and has a flop index of from 8 to 22 and/or a brightness as indicated by the luminance at 15 (L*_{15°}) of from 55 to 95, both determined using a BYK-Mac I Spectrophotometer.

18. The coating layer of claim 1, wherein the film forming component comprises an ecoat coating formulation and wherein the pigment in the pigment component provides a substantially uniform effect to the outermost surface of the coating layer or a portion thereof, wherein the uniform effect optionally comprises a color effect and/or a metallic effect, or wherein the pigment is within the bulk and/or the innermost surface of the coating layer and provides corrosion resistance.

19. The coating layer of claim 1, wherein the hardened coating layer has a surface roughness, or Ra, of less than 5 μm as measured according to ISO method 4287-1997.

20. A substrate coated at least in part with the coating layer of claim 1, wherein the substrate comprises a metallic substrate, a polymeric substrate, a composite, or combinations thereof.

21. The substrate of claim 20, wherein the film forming component comprises an ecoat, and the pigment in the pigment component comprises a metallic flake and/or corrosion inhibitor; the film-forming component comprises a primer and the pigment component comprises a corrosion inhibitor; or the film forming component comprises a powder coating formulation and the pigment component comprises a visual effect pigment; and optionally wherein the substrate comprises one or more additional coating layers under and/or over the hardened coating layer, such as wherein the additional coating layer comprises a primer layer, a basecoat layer, a topcoat layer, a clear coat layer and/or an adhesive layer.

22. (canceled)

23. The substrate of claim 20, wherein the substrate forms at least part of a vehicle, an article of manufacture, a consumer electronic device, a consumer appliance, or a structure.
